(19) United States
(12) Patent Application Publication
(10) Pub. No.: US 2026/0347258 A1
(43) Pub. Date: Nov. 5, 2026

(54) A METHOD FOR HYDRATING SILICATE MINERAL MATERIAL AND HYDRATED SILICATE MINERAL MATERIAL

(71) Applicant: GEOMATERIA OY, Vantaa (FI)

(72) Inventors: Juho YLINIEMI, Oulun yliopisto (FI); Rajeswari RAMASWAMY, Oulun yliopisto (FI)

(21) Appl. No.: 19/487,846

(22) PCT Filed: May 24, 2024
(86) PCT No.: PCT/FI2024/050270

§ 371 Date: Nov. 25, 2025

(30) Foreign Application Priority Data
May 26, 2023 (FI) 20235587

(51) Int. Cl. C04B 28/08; C04B 7/14; C04B 24/02; C04B 28/02

(52) U.S. Cl. CPC C04B 28/08; C04B 7/14; C04B 24/02; C04B 28/021

(57) ABSTRACT

The present disclosure provides a method for hydrating multioxide silicate material, the method comprising providing silicate mineral material, providing solution containing an alkali activator and a ligand, and mixing amorphous multioxide silicate material with the solution containing the alkali activator and the ligand to obtain a mixture. The present disclosure also provides hydrated silicate mineral material obtained by the method and concrete comprising the hydrated silicate mineral material. The present disclosure also provides a product comprising or consisting of ceramic-like or concrete material comprising the hydrated silicate mineral material or the concrete. The present application also provides use of dihydroxy aromatic compound and use of the hydrated silicate mineral material.

### FIELD OF THE APPLICATION

The present application relates to a method for hydrating silicate mineral material, to hydrated silicate mineral material and to concrete comprising the hydrated silicate mineral material and aggregate material. The present application also relates to products comprising or consisting of ceramic-like or concrete material comprising the hydrated silicate mineral material or the concrete. The present application also relates to use of a dihydroxy aromatic compound and to use of the hydrated silicate mineral material.

### BACKGROUND

Alkali activation of blast furnace slag (BFS) is one of the potential alternative binder materials to replace Portland cement in concrete. Alkali activation of BFS is carried out with different activators like sodium hydroxide (SH), sodium silicate (WG), sodium carbonate (SC), sodium sulphate (SS), or with a mixed system of activators. The mechanical properties and hydration kinetics of alkali activated materials (AAMs) is dependent on precursor's physical and chemical properties (e.g. fineness and chemical composition), type of alkali activator (pH and anion type), co-binders or admixtures, water-to-binder ratio (w/b) and curing temperature. The main hydration products of BFS with all the activators is C—(N)-A-S—H and Mg—Al double layered hydroxides. While WG and SH produce high early-strength, problems involving them are rapid setting, high drying shrinkage, reduction in flexural strength, and microcracking properties. Another important issue with WG and SH activators is their high cost and corrosive property leading to high risk in handling during AAM production.

However, the problem with activators are long setting time. typically ≥1 d, and slow strength evolution at the early stages. For example, hydration of SC-activated slag occurs via following process: at the initial stages, carbonate ions from activator react with dissolved Ca²⁺ ions and induce formation of carbonate salts such as calcite and gaylussite. This consumption of carbonate ions increases pH, thereby accelerating the dissolution of BFS and hardening reactions. Once the pH is increased, the reaction mechanism is similar to SH-activated BFS system. The delay in reaching the high alkaline pH only after consumption of carbonate ions lengthens the setting time and hardening reactions leading to eventual poor mechanical strength at early age.

Utilization of environmentally friendly activators with inorganic mineral side streams to form AAM is not feasible due to low strength evolution at the early days which obstruct the use of these activator in the construction sector.

Extensive research work on accelerating the hardening reaction and developing good mechanical properties at early stages of SC activated of BFS has been accomplished with chemical additives or co-binders such as fly ash, OPC, silica fume, fluorogypsum, reactive MgO, hydromagnesite seeds, CaO, calcined layered double hydroxides, zeolite, limestone, inflation agents, and kieselguhr as well as combining of other activators like SH and Ca(OH)₂ or WG and SS with SC. However, most of these methods are expensive, and their production requires high energy and cost and can increase the carbon footprint of the resultant AAM greatly. Additionally, use of high percentage of admixtures like double layer hydroxides or MgO results in formation of excess hydrotalcites which can result in cracking and affect the durability of the AAMs.

A different approach to accelerate BFS hydration is to use ligands as admixtures. Ligands are organic or inorganic compounds which could be potentially used in cements to affect the dissolution-precipitation kinetics and pH of the pore solution through complexation with different chemical species in the pore solution.

There is a need to create a solution for problems that could benefit in the terms of cost, efficiency, sustainable use of natural resources, such as sodium carbonate, and environment, such as by reducing carbon footprint responsible from the construction sector.

### SUMMARY

The present disclosure relates to alternative cementitious material that can be used in concrete and earth stabilization, for example. The present disclosure provides sustainable cementitious binders (geopolymers) with very low carbon footprint, for example compared to Portland cement, by using eco-friendly alkali solutions, such as having a low pH, and being cheap and naturally abundant, and granulated blast furnace slag or other similar industrial side stream. The initial slow reaction that often occurs with these eco-friendly solutions due to the low pH is a big challenge, that is solved by the method disclosed herein. Through this new avenue for wider use of these eco-friendly binders in construction sector will be opened.

Disclosed are organic/inorganic admixtures at low concentration in the system which helps to control the hydration kinetics by altering the reactions that occur in the system.

The present application provides a method for hydrating silicate mineral material, such as multioxide silicate material, the method comprising
providing silicate mineral material, such as amorphous multioxide silicate material,
providing solution containing an alkali activator and a ligand, and
mixing the silicate mineral material, such as the amorphous multioxide silicate material, with the solution containing the alkali activator and the ligand to obtain hydrated silicate mineral material.

The present application also provides hydrated silicate mineral material comprising a dihydroxy aromatic compound and/or obtained by the method.

The present application also provides concrete comprising the hydrated silicate mineral material and aggregate material.

The present application also provides a product comprising or consisting of ceramic or concrete material, comprising the hydrated silicate mineral material or the concrete.

The present application also provides use of a dihydroxy aromatic compound, for hydrating silicate mineral material with the method.

The present application also provides use of the hydrated silicate mineral material as a binder in concrete.

The main embodiments are characterized in the independent claims. Various embodiments are disclosed in the dependent claims. The embodiments and examples disclosed herein are mutually freely combinable unless otherwise explicitly stated.

It was found out that the present aromatic hydroxyl compound ligands, especially dihydroxy aromatic compounds, could accelerate hydration kinetics of alkali-activated silicate mineral material and produce high strength. Mechanism behind the effect may be based on affecting the ion activity product of layered double hydroxides or C-(A)-S—H phases and not hindering the underlying carbonate salts, such as gaylussite or calcite, precipitation kinetics. The present ligands can inhibit or accelerate the hydration kinetics depending on their functional group and concentration in the binder system. For example 2,3-dihydroxynaphthalene accelerated the hydration kinetics by 28 h and performed better compared to others. The ligands can change phase assemblage, form new phase, and can increase the extent of precipitation of phases. The use of the present ligands enables efficiently using any alkali activator, including inexpensive ones.

The present methods and materials enable providing inexpensive, less corrosive and environmentally friendly solutions, for example having a lower carbon footprint, lacking hazardous compounds, utilizing recycled and/or waste materials and saving energy. With the fast hydration and hardening it is possible to produce a variety of products more efficiently and with higher accuracy. A variety of different operators can utilize the present method and materials, for example in industrial scale. The method can be implemented at existing production sites, such as on site, using existing equipment, so no additional investments or specific know-how are required. The present methods and materials can benefit the whole production chain of preparing hydrated silicate materials and products.

### BRIEF DESCRIPTION OF THE FIGURES

FIG. 1 shows isothermal calorimetry results of SC-activated BFS samples with ligands (a) TEA & TIPA, (b) NTA & TKPP, (c) DHNP with concentrations 25-150 mM, respectively.

FIG. 2 shows compressive strength of SC-activated BFS samples with and without ligand (Reference).

FIG. 3 shows XRD of SC-activated slag (a) Reference sample (1-7 d); b) reference and ligand samples after 7 d (ligand dosages based on microcalorimetry results).

FIG. 4 shows DTG curves of reference and ligands as a function of temperature (a) TEA, b) TIPA, c) NTA, d) TKPP, and e) DHNP.

FIG. 5 shows pH of the sample suspensions (L/S 1.05) with and without ligands.

FIG. 6 shows pore solution compositions with and without ligands with liquid-to-solid ratio (w/w) of 1.05.

### DETAILED DESCRIPTION

In this specification, percentage values, unless specifically indicated otherwise, are based on weight (w/w, by weight, or wt %). The open term “comprise” may be limited with a closed term “consisting of” as one option.

The present application provides a method for hydrating silicate mineral material, such as multioxide silicate material, which may be a method for preparing hydrated silicate mineral material, such as hydrated multioxide silicate material.

The hydrating may be carried out in a context of further methods, such as in a method for preparing any of the products disclosed herein, for example in a method for preparing and/or using the binder disclosed herein and/or in a method for preparing cement and/or concrete. The present materials can be used to replace Portland cement and other pozzolanic material or other binders in concrete and the like materials. The present silicate mineral material in general causes the cement to set more slowly than conventional Portland cements and the like, but the present method enables accelerating this process.

The method may comprise
providing silicate mineral material, which may be multioxide silicate material, such as amorphous multioxide silicate material,
providing solution containing an alkali activator and a ligand/an aromatic hydroxyl compound, and
mixing the silicate mineral material with the solution containing an alkali activator and a ligand to obtain a mixture.

Alkali-activated silicate mineral material is obtained after the alkali activator and the silicate mineral have reacted. The mixing may be carried out with a mixer, such as with a stirrer or any other suitable mixer. The mixing may be carried out for 15 minutes of more, such as 15-120 minutes, for example 15-60 minutes. The mixing is preferred for the present materials and it enhances the activation, hydration and the obtained effects and properties of the obtained material and products. The mixture may be hydrated silicate mineral material or hydrated multioxide silicate material, a mixture of hydrated silicate mineral material or hydrated multioxide silicate material, or the hydrated silicate mineral material or the hydrated multioxide silicate material may be obtained and/or formed from the mixture. Mineral hydration occurs in the mixture, which is a reaction which adds water to the crystal structure of the mineral. The solution is an aqueous solution thus providing water, and it contains one or more alkali activator(s).

The silicate mineral material, which may be latent hydraulic binder, may comprise multioxide silicate material, such as amorphous multioxide silicate material. The material is present in solid form and may be ground and may be in the form of powder, particles, granules and/or the like. In one example the material is multioxide silicate powder. The embodiments and examples disclosed herein by applying the multioxide silicate material can be applied to any other suitable silicate mineral materials as well.

The silicate mineral material or the multioxide silicate material may be any suitable silicate mineral material or multioxide silicate material, such as material selected from slag, such as blast furnace slag (BFS), slag sand, ground slag sand, electrothermic phosphorus slag, (stainless) steel slag or ladle slag, or combinations thereof; ash, such as coal combustion ash, biomass ash or municipal waste incineration ash; glass waste; mineral wool such as glass wool or stone wool; and mine tailings, and combinations thereof.

The slag may be industrial slag, which may be a waste product from industrial process, and/or synthetic slag, which is synthetically reproduced slag. Blast furnace slag, which may be ground granulated blast furnace slag, is a waste product of the blast furnace process and can be obtained by quenching molten iron slag from a blast furnace in water or steam, to produce a glassy, granular product that is then dried and ground into a fine powder. Ground granulated blast furnace slag is a latent hydraulic binder forming calcium silicate hydrates (C—S—H) after contact with water. Slag sand is granulated blast furnace slag and ground slag sand, or ground granulated blast furnace slag, is finely pulverized slag sand.

Electrothermic phosphorus slag is a waste material obtained from the production of phosphorus by electrothermic means. It is less reactive than blast furnace slag. Stainless steel slag is a waste product from various steel manufacturing processes, with a highly varying composition.

The specific surface area of the silicate mineral material, such as the slag, may be in the range of 200-1000, such as 300-500 m²/kg, expressed as Blaine value. It can be determined from air permeability tests using a Blaine permeameter. The particle size distribution of the silicate mineral material, such as the slag, as D₅₀ may be 50 μm or less, such as 30 μm or less, for example 20 μm or less, such as D₅₀ may be in the range of 15-50 μm, such as in the range of 15-30 μm, for example in the range of 15-25 μm, determined by laser diffraction method.

The present ligands are added to accelerate the hydration of the silicate mineral material. Ligands may be selected based on their ability to complex with metal ions that are rich in BFS such as Ca, Si and Al. Triethanolamine (TEA) and triisopropanolamine (TIPA) are known in the cement field for their ability to complex with Ca, Al, and Fe, whereas trisodium nitrilotriacetate (NTA) and tetra potassium pyrophosphate (TKPP) are known in the detergent application to soften the hard water by forming soluble complexes with Ca, Mg ions.

The present ligands comprise and/or are aromatic hydroxyl compounds. The aromatic hydroxyl compound may be dihydroxy aromatic compounds, which comprise an aromatic ring structure with two hydroxyl functional groups, preferably comprising an aromatic ring structure with two hydroxyl functional groups that are attached to neighbouring carbon atoms of the aromatic ring.

Dihydroxy aromatic compounds, such as 2,3-dihydroxy aromatic compounds, for example 2,3-dihydroxynaphthalene (DHNP), which is a ring fused catecholate, can act as replacement for environmentally hazardous catechol which can complex with tetravalent ions like Si and Ti, in addition to Ca and Al. Ring-fused dihydroxy aromatic compounds are preferred, and they refer to an aromatic ring structure with two or more, such as three, aromatic rings attached, such as fused and/or directly attached, to each other and comprising two hydroxyl functional groups, such as one ring comprising two hydroxyl functional groups. The aromatic ring structures preferably comprises two hydroxyl functional groups that are attached to neighbouring carbon atoms of the aromatic ring.

Compounds comprising a catechol group, especially a non-fused and/or non-ring-fused catechol group, such as 2,3-dihydroxybenzoic acid, are not desired as ligands in the present methods and materials, for example as they represent harmful substances, which are not desired for example for environmental reasons. In one example the ligand does not comprise and/or is not a non-fused catechol group. In one example the ligand comprises and/or is a fused catechol or catecholate, such as ring-fused catechol or catecholate.

Ligand dosage of less than 1 wt. % of mass of the precursor could potentially fulfil the intended application as in the cement or alkali activated systems concentrations of admixtures can reach up to several tens or hundreds of millimoles per litre in the pore solution during the initial hours.

The ligands may be provided as solid, such as in the form of powder, granules and/or pellets.

In one embodiment the ligand comprises or is dihydroxy aromatic compound. In one embodiment the dihydroxy aromatic compound is 2,3-dihydroxy aromatic compound. These compounds were found suitable for the present uses, and they enabled efficient acceleration of the hydration and fast hardening of the present silicate mineral materials, but did not affect the reaction kinetics of carbonate salts. In one embodiment the 2,3-dihydroxy aromatic compound is 2,3-dihydroxynaphthalene (DHNP), which was found especially efficient ligand for the present purposes, particularly with the amorphous multioxide silicate materials.

The ligand may be combined with the alkali activator solution at different points and in different forms. The method may comprise adding the ligand into the alkali activator solution prior to mixing as dry powder or as water solution during raw material mixing, and/or as dry powder or as water solution during grinding process of the silicate mineral material. This enables implementing the method practically in any existing process or existing production site, as well as controlling the process.

In one embodiment the alkali activator comprises sodium carbonate, potassium carbonate, sodium silicate and/or sodium sulphate. In one embodiment the alkali activator comprises sodium carbonate, potassium carbonate and/or sodium sulphate.

Activators such as sodium carbonate and sodium sulphate are preferable as they are cheaper, less corrosive, and have lower carbon footprint compared to sodium hydroxide and sodium silicate. In addition, sodium carbonate activated silicate mineral shows advantageous properties like low shrinkage and good mechanical strength at later stage. It may be desired that the alkali activator does not comprise sodium hydroxide and/or sodium silicate.

The alkali activator may be provided in a suitable concentration to obtain a desired degree of activation. In one embodiment the concentration of the alkali activator in the solution is in a range of 0.1-15 M, such as 0.1-5 M, for example 0.5-2 M.

The ligand may be provided in a suitable concentration to obtain a desired degree of complexation, which may depend on the other materials, such as on the composition of the silicate mineral material. However, it was found out that with the present ligands a lower concentration of the ligand could provide even better results than a higher concentration. In one embodiment the concentration of the ligand in the solution is in the range of 5-1000 mM, such as in the range of 10-500 mM, for example 20-200 mM. However, for dihydroxy aromatic compounds it was found out that concentrations below 100 mM worked better, so the concentration of the ligand in the solution may be in the range of 20-100 mM or 20-80 mM, such as in the range of 20-50 mM, for example about 25 mM.

In one embodiment the ratio of the solution/liquid to the silicate mineral material, such as to the amorphous multioxide silicate material, is 1 or less, such as in the range of 0.2-1.1 or 0.2-1, preferably 0.2-1.0, such as in the range of 0.3-1, preferably 0.3-1.0 or 0.2-0.6, for example about 0.35.

The method may comprise allowing the mixture to harden at a temperature in the range of 0-200 °C or 0-100 °C, such as in the range of 10-80 °C, for example in the range of 20-40 °C.

The method may comprise adding the ligand to solution comprising the activator prior to mixing with the silicate mineral material, such as the amorphous multioxide silicate material. This may be carried out for suitable time enabling the ligand to dissolve completely or substantially completely, such as 15 minutes or more prior to mixing, for example 15-60 minutes prior to mixing. This is required especially when the dissolution of the ligand to the alkali activator solution is slow or incomplete, such as in the case of sodium carbonate and/or a specific ligand. For example, the ligand 2,3-dihydroxynaphthalene is not immediately completely soluble in the activator solution prior to mixing and it needs at least 15 minutes mixing to effectively dissolve the ligand. During mixing, the ligand dissolves in contact with the silicate mineral material, such as BFS, due the pH environment and the metal-complexing ability of the ligand with the silicate mineral.

The mixture may be used to prepare products, such as final products, which may be any of the products disclosed herein, parts thereof or precursors thereof. The products may have a specific shape and/or form, which may be obtained by using a mould or the like support, wherein the hydrated material can set and/or harden in the accelerated manner thus facilitating obtaining products with more accurate shapes and dimensions. The mixture may be used as such or it may be formed into concrete or the like compositions, which may contain one or more additives, such as fillers and the like, for example aggregate material, such as sand, gravel, or any other suitable aggregate material, and/or fibers. The method may comprise casting the mixture into one or more moulds and/or otherwise forming a desired shape of a product.

The method may comprise
adding aggregate material, such as material comprising or consisting of sand, gravel, wood, glass, plastic, ceramic material, for example as crushed or ground, plant-based cellulose fibers or fibrils, such as cellulose microfibrils or cellulose nanofibrils, and/or synthetic fibers or any other suitable aggregate material to the mixture and/or to the hydrated silicate mineral material, and
mixing to obtain concrete. The concrete may be allowed to set and/or harden. The method may be a method for preparing concrete.

The method may comprise allowing the obtained mixture to hydrate for 24 hours of more. This may be carried out at sealed conditions to prevent evaporation and/or to protect from the effect of atmospheric CO₂.

The method may comprise allowing the obtained mixture to set and/or harden for a suitable time, which may be 1-168 hours, such as for 1-72 hours, for example 24-168 hours, to obtain set and/or hardened hydrated multioxide silicate material.

One example provides a method comprising
mixing amorphous multioxide silicate material powder, such as blast furnace slag (BFS), with solution containing sodium carbonate, such as about 2 M or a range disclosed herein, and dihydroxy aromatic compound, such as about 25 mM or a range disclosed herein, at a solution to powder ratio of about 0.35, or a range disclosed herein, for 15 min or more in mixing, such as with a stirrer, to obtain a mixture, and
casting the mixture into one or more moulds and/or forming into products and/or shape of products.

The present application provides hydrated multioxide silicate material obtained by the method disclosed herein and/or comprising dihydroxy aromatic compound. The material contains the agents disclosed herein, so the production method may be detected from the hydrated material for example by identifying the presence and/or the amount of the ligand and/or the silicate mineral material, such as the amorphous multioxide silicate material. Especially the presence of the ligand, for example in a complex or as complexed in the material, indicates the production method as there is no other reason for the ligand to be present in such a hydrated material.

The present application provides concrete comprising the hydrated silicate mineral material disclosed herein and aggregate material, such as material comprising or consisting of sand, gravel, wood, glass, plastic, ceramic material, for example as crushed or ground, plant-based cellulose fibers or fibrils, such as cellulose microfibrils or cellulose nanofibrils, and/or synthetic fibers.

The present application also provides products, which may be or comprise ceramic-like or concrete material, such as a product selected from ceramic and concrete products and ceramic-like or concrete types of materials and products comprising the hydrated silicate mineral material or concrete comprising the hydrated silicate mineral material. The products may comprise one or more of panels, boards, sheets, acoustic panels, tiles, slates, mortar, coating, basins, washbowls, toilet bowls, vases, pots, slabs, well rings, earth construction materials and products, and the like. The panels may be floor panels, ceiling panels, wall panels or any other applicable panels, which may be indoor panels or outdoor panels, or other indoor and/or outdoor products.

The present application provides use of dihydroxy aromatic compound for hydrating silicate mineral material, such as multioxide silicate material, with the method disclosed herein. The present application provides use of dihydroxy aromatic compound, for example as a ligand, for preparing a binder for concrete and/or for preparing concrete and/or cement. The present application provides use of dihydroxy aromatic compound, for example as a ligand, for hydrating silicate mineral material for preparing a binder for concrete and/or for preparing concrete and/or cement.

The present application provides use of the hydrated silicate mineral material, such as hydrated multioxide silicate material, as a binder in concrete.

Disclosed is use of the mixture as an aid to promote acceleration of hardening reaction and enhancement of the early mechanical properties (≤7 d) of SC activated silicate solely.

The present disclosure provides use of an of the agents or combinations thereof in any of the methods disclosed herein, such as for preparing any of the materials disclosed herein. The present disclosure also provides substances and materials obtained with the methods disclosed herein.

### Examples

### 1. Introduction

The present examples provide a detailed investigation on how ligands TEA, TIPA, NTA, TKPP and DHNP at concentration between 25-150 mM affect the early-stages of SC-activated BFS hydration. First, the effect of ligand functional group and ligand concentration in SC activator system was studied by isothermal calorimetry and compressive strength measurements. Following that, the most promising ligand concentrations were studied by XRD and TGA to identify the formation of different hydration products and to follow the reaction process. Batch dissolution experiments were conducted to understand the effect of ligands on pH development, extent of BFS dissolution, and elemental pore solution chemistry.

In particular, following research questions were pursued to answer in this study: 1) what type of influence does ligand functional group and concentration have on BFS hydration; 2) does higher pH initiated by ligand play a key role in the hardening process 3) do ligands affect formation of different phases, and if so, how it will affect the hardening process?

### 2. Materials and Methods

### 2.1 Materials

BFS with product name KJ 400 (Finnsementti, Finland) with the chemical composition (determined by XRF) and the particle size distribution with a median particle size d₅₀ (determined by laser diffraction method) shown in Table 1 was used throughout the experiments. XRD revealed that BFS was amorphous with a hump around 25-45° 2Θ indicating a glassy phase structure and with small amounts of calcite that may have formed due to the reaction with atmospheric moisture and CO₂ during storing. Sodium carbonate solution was prepared by mixing analytical grade Na₂CO₃ powder (from Sigma Aldrich) with deionized water.

Analytical grade of ligand powders of TEA (from VWR), NTA (from Sigma), TKPP (from Sigma), TIPA (from Sigma) and DHNP (from Sigma) added to the activator solution <15 min prior to mixing with BFS.

TABLE 1
Chemical composition (wt. %) and median particle size (μm) of BFS

| | Oxides | | | | | | | | | | | | |
|---|---|---|---|---|---|---|---|---|---|---|---|---|---|
| | | | | | | | | | | | | | D₅₀ |
| | CaO | SiO₂ | Al₂O₃ | Fe₂O₃ | Na₂O | K₂O | MgO | TiO₂ | MnO | SO₃ | V₂O₅ | Cl | (μm) |
| wt. % | 39.39 | 34.44 | 9.21 | 0.72 | 0.43 | 0.77 | 9.48 | 1.19 | 0.25 | 1.86 | 0.09 | 0.13 | 19.76 |

### 2.2 Mix Designs

Blast furnace slag (BFS) powder and activator solution with and without ligand of respective concentrations 25, 100, and 150 mM was mixed for 15 min at 800-1000 rpm using a mechanical stirrer. Activator dosage was 5 wt. % as Na₂O equivalent of mass of BFS. The liquid to binder ratio used for all paste samples is 0.35. All the ligands except DHNP dissolved quickly in the SC solution, whereas DHNP dissolution was slower in SC, but did dissolve fully after mixing with SC and BFS as evidenced by the disappearance of DHNP pellets and colour change of the mix. After mixing, sample pastes were cast into 2*2*8 cm steel moulds and were mechanically vibrated to remove air bubbles and attain proper consolidation. All pastes were hydrated at 23 °C under closed plastic film for 24 h to prevent water evaporation and effect of atmospheric CO₂. After 24 h, samples were demoulded and kept in plastic sealed bags until further studies. Sample without ligands is represented as reference, whereas samples with ligands (L) and different concentrations (C) are represented as LC.

### 2.3 Characterization Techniques and Methods

### 2.3.1 Isothermal Microcalorimetry

The heat release of the paste samples was recorded using TAM air isothermal calorimeter at 23 °C. Plastic ampoule holder was used for samples and deionised water was used as a reference. The samples were first prepared by mixing for 15 min at 800-1000 rpm and then transferred to the plastic ampoule which was then loaded into the calorimeter. Reported results were normalised by the total mass of the fresh paste of each sample and adjusted considering the duration taken for sample preparation.

### 2.3.2 Compressive Strength

Compressive strength measurement after 1, 2, 3, and 7 days of curing were carried out using a calibrated Zwick/Roell (Z100) machine with a load of 100 kN and with a loading capacity at a constant displacement rate of 1.8 mm/min. Steel plates of 2*2 cm was inserted above the sample to have a uniform surface area for all samples during the measurement. An average value and standard deviation of 3 replicates is reported for each sample.

### 2.3.3 Phase Analysis

After the compressive strength measurements, solvent exchange drying method was opted for stopping the hydration reaction. For this, the crushed samples (around 3-5 g) were dipped in isopropanol (60-100 ml) and stirred for 20 min and filtered using 2-5 μm particle retention Whatman paper. The filtered solids were then added to fresh isopropanol again and after 1 d filtered and dried. This procedure was carried out to stop hydration process prior to analyses. After the samples are completely dried, they were grinded into a fine powder using agate mortar and pestle. The grinding time was uniform to all sample. These dried samples are then used for the following phase analysis.

Powder XRD measurements were performed using Rigaku SmartLab with a Co source lamp of 40 kV and 135 mA. The crystalline phases were identified using PDXL2 software with the ICDD PDF4+ 2015 database. The TGA/DTG analysis were carried out using simultaneous thermal analyser (SDT 650, TA instruments). Powder samples placed in platinum holder were heated from 30 to 1015 °C at 10 °C/min in N₂ atmosphere.

### 2.3.4 Dissolution Experiments

A batch dissolution experiment was conducted with a liquid-to-solid ratio (L/S) of 1.05 (w/w), and the pore solution was extracted using vacuum filtration. The filtrate was then passed through a 0.45 μm pore filter syringe. It was then acidified with 1% HNO₃ solution for ICP analysis. pH of the suspensions before acidification was carried out using Accumet model 20 pH meter and each measurement was repeated at least 5 times to get an average value with an accuracy of ±0.1. ICP analysis was done according to the standard method SFS-EN ISO 11885:2009.

### 3. Results

### 3.1 Effect of Ligands on Hydration Kinetics

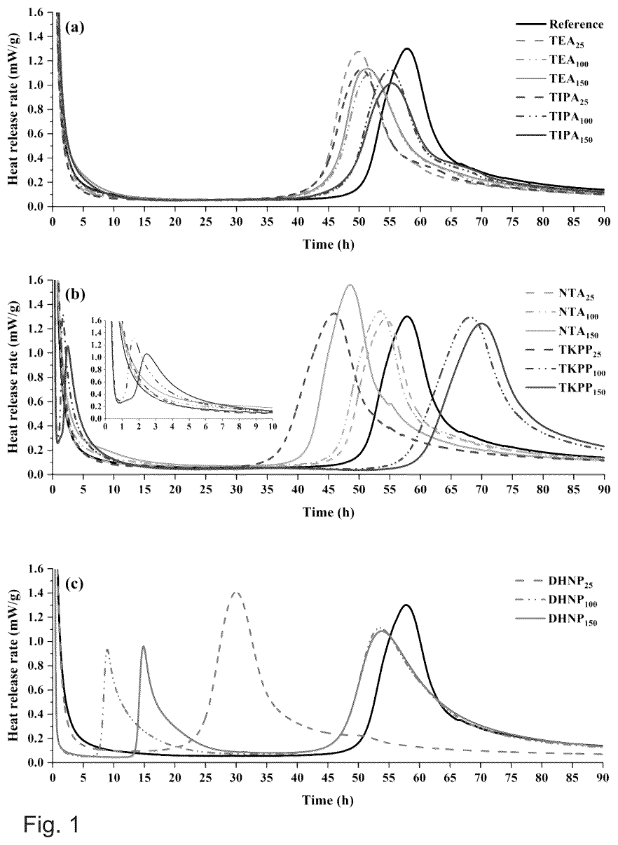

Results showed significant differences on the rate of heat evolution (FIG. 1) between SC-activated samples with and without ligands. For the reference sample, the induction period was prolonged until 45 h and the main exothermic peak reaches a maximum around 58 h. This is concurrent with the results in other studies. It is worth to note that the reaction was not completely ceased during the induction period as there was residual heat rate observed for all samples.

Samples with ligands showed acceleration/deceleration of the main exothermic peak, change in the intensity of the peaks, and formation of new peaks which indicates that the ligand functional group and concentration can affect reaction kinetics and reaction mechanism. Observations that support the above-mentioned statement: compared to the reference, all the ligand system exhibited acceleration of the main exothermic peak and reduction of induction period except for TKPP_{100,150} samples. Between the respective ligand systems, ligand concentration of 25 mM (TEA₂₅ and TIPA₂₅ about 50 h; DHNP₂₅ about 30 h; TKPP₂₅ at about 46 h), and 150 mM (NTA₁₅₀ at about 49 h) accelerated the formation of the main exothermic peak better. Among them, DHNP (aromatic dihydroxyl functional group) accelerated the reaction kinetics more than other ligands. Increasing the ligand concentration from 100 to 150 mM retarded the acceleration of the main exothermic peak formation with most of the ligands (TEA, TIPA, TKPP, and DHNP). However, the effect of concentration was opposite with NTA. Formation of new initial exothermic peak in addition to initial dissolution and wetting peak was observed within 24 h for samples TKPP₁₀₀ (at ~2 h), TKPP₁₅₀ (at ~2.5 h), DHNP₁₀₀ (at ~9 h), and DHNP₁₅₀ (at ~15 h)

FIG. 1 shows isothermal calorimetry results of SC-activated BFS samples with ligands (a) TEA & TIPA, (b) NTA & TKPP, (c) DHNP with concentrations 25-150 mM, respectively.

Based on the isothermal calorimetry results, a total of 11 samples (including reference) for compressive strength measurement was prepared where it comprises of 5 promising ligand dosages based on acceleration of the maxima of main exothermic peak and an additional of 5 samples with 100 mM ligand dosages for comparison. However, it was kept in mind that there is not necessarily direct correlation between heat of hydration and strength development, but the final set usually occurs close to the main exothermic peak and the hardening commences following the final setting.

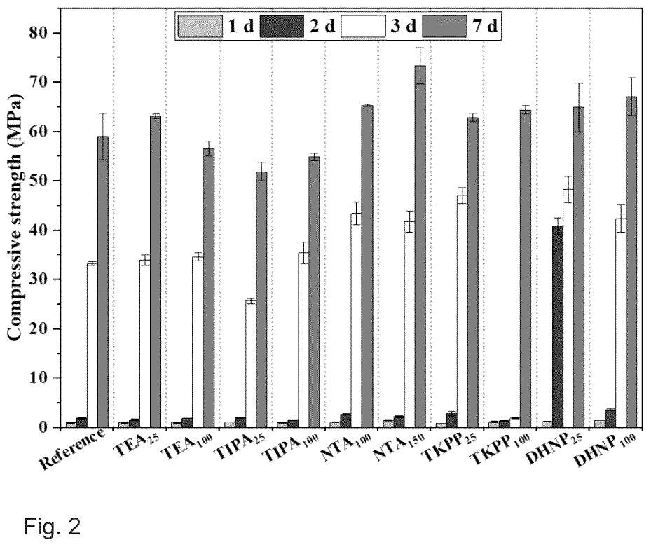

FIG. 2 represents the effect of selected ligand systems on the compressive strength. Reference showed 1 d compressive strength of about 1 MPa. This is an expected result as previous studies have shown that the main hardening reaction of SC-activated slag binders with similar BFS chemical composition as here starts between 3 and 7 days. Here, ligand efficiency in terms of increasing the early strength is dependent on functional group and concentration.

Organic ligands such as TEA, TIPA, and NTA have tripodal amino backbone structure but with varying functional group (hydroxy in TEA, methyl hydroxy in TIPA, and carboxylic in NTA; Fig. S3). NTA worked best at increasing the 3-7 d compressive strength among others and TEA performed better compared to TIPA. TKPP which represent inorganic pyrophosphates, seemed to perform better compared to TEA and TIPA at low concentrations (25 mM), while with higher concentration (100 mM) TKPP retarded the strength development which can be clearly observed in 3 d results. DHNP, representing aromatic dihydroxyl structure, accelerated the hydration kinetics more than other ligands according to microcalorimetry results which correlates well with the strength results by exhibiting a strength of about 41 MPa at 2 d compared the reference which only had about 2 MPa. From microcalorimetry results, samples containing TKPP or DHNP with concentrations 100 to 150 mM showed formation of new exothermic peak during the first 24 h. However, that did not correspond to a noticeable difference in the strength as the differences were within the margin of error compared to reference.

### 3.2. Effect of Ligands on Phase Evolution

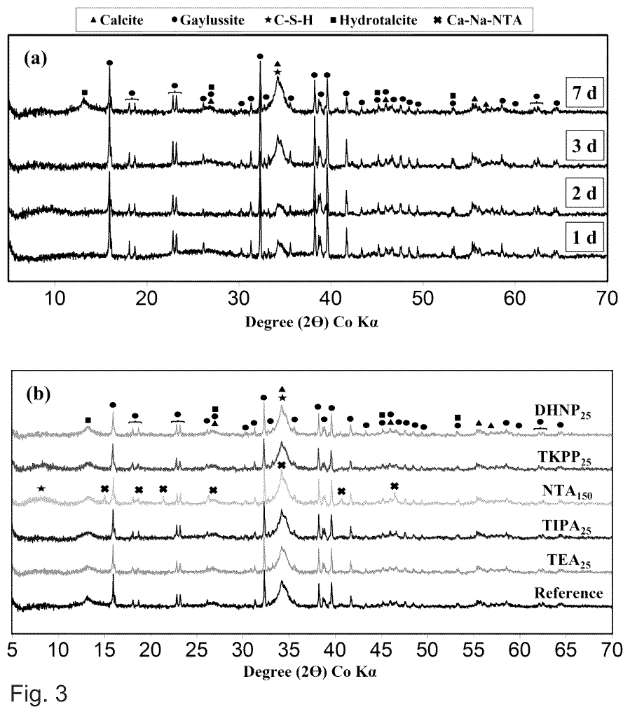

FIG. 3a shows the XRD patterns of 1-7 d reference samples. The results showed that at 1 d, precipitation of gaylussite was evident along with calcite, which corresponds with previous studies. The main hydration products observed after 7 d were calcite CaCO₃ (PDF #072-1937), gaylussite Na₂Ca(CO₃)₂·5H₂O (PDF #010-3621), poorly ordered C-(A)-S—H identified here as calcium silicate hydrate Ca_{1.5}SiO_{3.5}·xH₂O (PDF #033-0306) and poorly ordered carbonate containing Mg—Al LDH phase identified here as hydrotalcite Mg₆Al₂CO₃(OH)₁₆·4H₂O (PDF #022-0700). As the reaction proceeds, from 3-7 d the intensity of peak corresponding to calcite and poorly ordered C-(A)-S—H was observed to increase in addition to formation of poorly ordered Mg—Al LDH. This initial formation of gaylussite and calcite at about 2 d did not produce high strength as seen in FIG. 2. Additionally, the intensity of the peak corresponding to gaylussite was decreased after 7 d indicating that it may be getting consumed during later stages of the hardening.

No significant differences in the XRD patterns and phase identification between reference and binders with ligands at 7 d (FIG. 3b) was observed except for the binder containing NTA. Calcium sodium nitrilotriethanoate C₆H₆CaNNaO₆ (Ca—Na-NTA; PDF #034-1982) along with gaylussite and calcite were identified in samples NTA₁₀₀ and NTA₁₅₀ from 1 d onwards. This demonstrates the strong complexing ability of NTA with Ca²⁺ and maybe Na⁺ ions by forming an insoluble complex product.

Additionally at 3 d, formation of a broad hump around 7-12° 2θ was observed only in case of NTA₁₅₀ sample, which then refined at 7 d into two peaks (5-10° and 13.1° 2Θ) where former corresponds to calcium aluminium silicate hydrate (C-(A)-S—H) phase tobermorite 11 Å Ca₅Si₆OH₁₈·5H₂O (a poorly crystalline Al substituted form; PDF #045-1480) and latter to hydrotalcite.

Another observation from XRD results of samples with 100 mM ligand concentration is that only NTA containing binder system formed a solid ligand complex (Ca—Na-NTA) whereas other ligand systems did not have any detectable ligand complex precipitation products. Possible explanations include that i) other ligands do not form complexes with metals within the experimental time and solution chemistry present in the system, ii) other ligand-metal complexes are water-soluble and remain in aqueous form in the pore solution, or iii) the ligand-metal complex is amorphous or in low quantity and thus not detectable with XRD analysis.

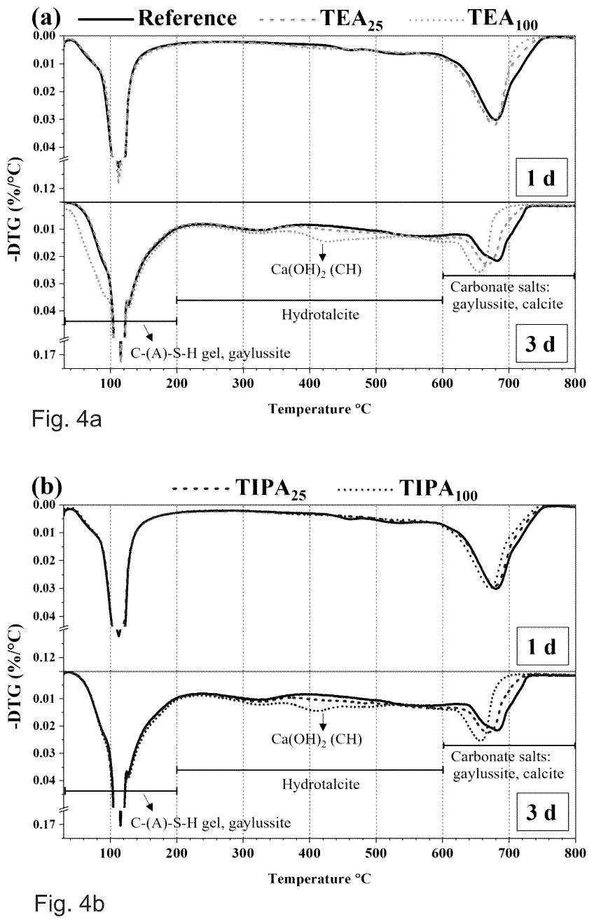

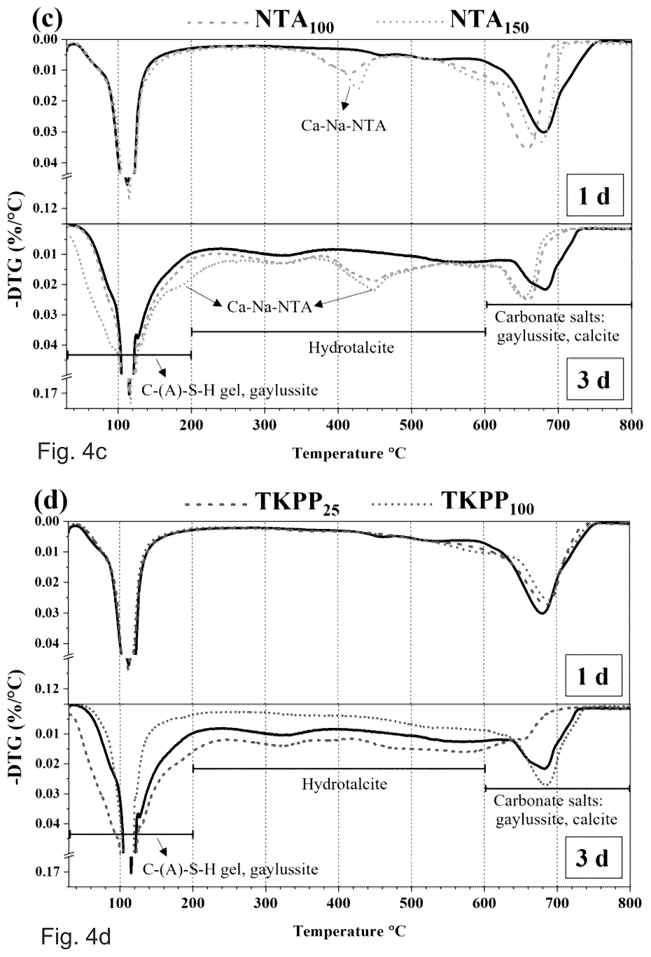

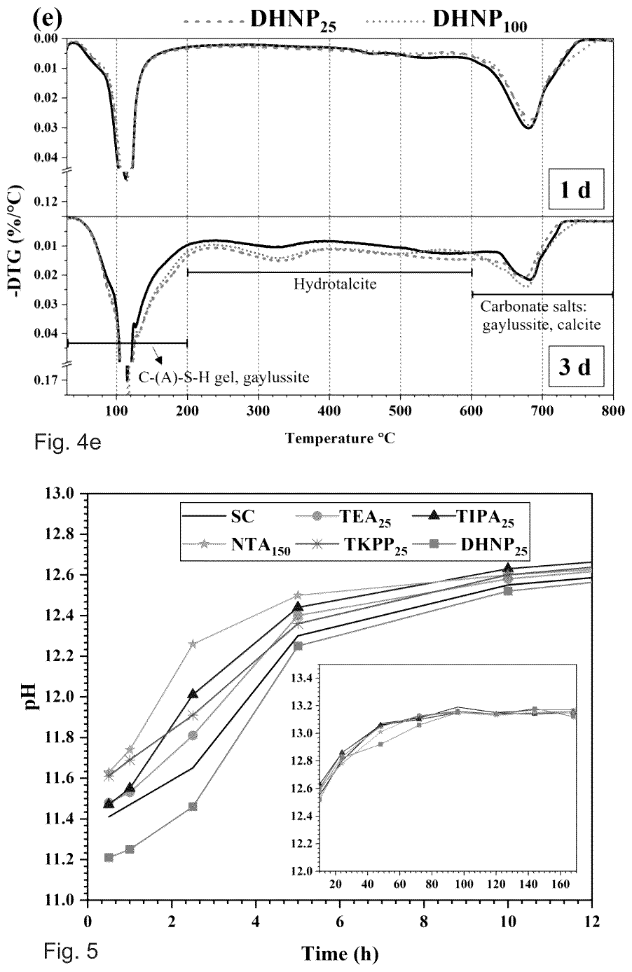

TG-DTG results of 1 d and 3 d samples are shown in FIG. 4 to understand the reaction mechanism by identifying and assigning the mass loss peaks corresponding to different phases which were identified by XRD analysis and from literature. From FIG. 4, TG-DTG analysis of reference sample indicates formation of carbonate salts (like gaylussite and calcite) around 1 d as mass loss corresponding to dehydration of gaylussite (around 120 °C) and the decarbonation of carbonate salts (600-800 °C) were observed. After 3 days of hydration, increase in mass losses due to dehydration of free and bound water from interlayer of C-(A)-SH gel (30-200 °C), and hydrotalcite (dehydration: around 200 °C; dehydroxylation: 250-400 °C; decarbonation: 450-600 °C) were observed. These observations correlate well with the XRD results. A decrease in the intensity of the mass loss due to decarbonation of the carbonate salts indicates that as the reaction proceeds from 1 to 3 d, gaylussite is consumed in the reaction process or transforms to calcite due to their stability dependence on the carbonate concentration in pore solution.

The DTG of all ligand samples at 1 d (FIGS. 4a-e), showed similar mass loss of dehydration curve (30-200 °C) compared to the reference. However, for both 1 d and 3 d samples, the mass loss due to decarbonation of carbonate salts (600-800 °C) showed variation of results depending on the ligand type and its concentration (except in DHNP system). Additionally, DTG results of sample TKPP₂₅ (FIG. 4d) at 3 d had lower mass loss corresponding to decarbonation peak of carbonate salts compared to other ligand samples and reference. These results indicates that ligands can affect the formation of carbonate salts during early-stage hydration of Na₂CO₃-activated BFS. The shift in the decarbonation peak observed in samples with TEA, TIPA, and NTA (both 1 and 3 d) (FIG. 4a-c) can indicate that the crystallinity of the carbonate products is different compared to reference and eventually altering their thermal decomposition temperature.

Results also showed the ability of the ligand to change the phase assemblage, formation of new phases (amorphous or crystalline), and increase the amount of precipitated phases. Increased mass loss in dehydration of chemically bound water (originating from C-(A)-S—H phases) was observed at 3 d in samples TEA₁₀₀, NTA₁₅₀, and TKPP₂₅, which implies that amorphous structure of the C-(A)-S—H phase is different, or increased precipitation of phases, compared to other samples. Mass loss corresponding a new peak around 400-500 °C was observed for TEA_{100,150} and TIPA_{100,150} samples. However, no additional crystalline phase was identified by XRD analysis for those samples compared to the reference. This implies that the phase formed in those samples could be amorphous. From literature, alkanolamines such as TEA have been observed to form amorphous Ca(OH)₂-ligand phases with 0.1-1 wt. % ligand dosages. Since TIPA is also an alkanolamine and the ligand dosage used in our study is similar, it is possible that the mass loss around 400-500 °C observed for TEA_{100,150} and TIPA_{100,150} samples could be due to formation of amorphous CH-ligand phases. Mass loss peaks corresponding to Ca—Na-NTA phase (dehydration: 142-219 °C; decomposition: 231-439 °C; decarbonation: 439-668 °C) were assigned to DTG of NTA_{100,150} samples as they are confirmed to precipitate during 7 days of hydration according to XRD results. Increased mass loss corresponding to hydrotalcite were only observed in samples TKPP₂₅ and DHNP_{25,100}, which indicates that TKPP and DHNP in the binder system can favour Mg—Al LDH formation.

TG-DTG of TKPP₁₀₀ showed that the total mass loss and DTG curve was similar for 1 d and 3 d samples, implying that hydration of the slag had ceased. This can be the reason for the retarded strength development of the sample TKPP₁₀₀ at 3 d (FIG. 4d). With addition to the retarding effect in the reaction degree, ligand, or its respective complex was not observed with XRD or TG-DTG analysis. One hypothesis is that there could be a possibility for ligand adsorption on the slag surface or phases.

Additionally, semi-quantitative information about the effect of ligands on the BFS hydration can be estimated from the total mass loss of the binder under temperature range 30-800 °C (Table 2) as the unhydrated BFS here had only 1.6% total mass loss under this range. This mass loss was corrected to binder sample results. The results showed that increasing TEA and TIPA concentration from 25 to 100 mM increased the hydration extent at 3 d compared to reference, whereas binder with NTA_{100,150} increased the hydration extent between 1 d and 3 d. TKPP₂₅ improves the hydration extent at 3 d compared to reference, but with increasing concentration the total mass loss was significantly lower compared to reference indicating retardation of hydration. Also, DHNP_{25,100} was observed to increase the hydration compared to reference at 3 d.

TABLE 2
Total mass loss (in wt. %) around 30-800 °C
of respective ligand samples
at different reaction times obtained from TGA.

| | Total mass loss % | | | Total mass loss % | |
|---|---|---|---|---|---|
| Sample | 1 d | 3 d | Sample | 1 d | 3 d |
| 2 (Ref.) | 5.4 | 8.5 | | | |
| 2_TEA₂₅ | 5.4 | 8.4 | 2_TEA₁₀₀ | 5.4 | 9.9 |
| 2_TIPA₂₅ | 5.1 | 8.8 | 2_TIPA₁₀₀ | 5.0 | 9.1 |
| 2_NTA₁₅₀ | 6.3 | 11.5 | 2_NTA₁₀₀ | 5.9 | 10.0 |
| 2_TKPP₂₅ | 5.2 | 10.7 | 2_TKPP₁₀₀ | 4.6 | 5.1 |
| 2_DHNP₂₅ | 5.0 | 10.2 | 2_DHNP₁₀₀ | 4.8 | 9.9 |

### 3.3 Effect of Ligand on Pore Solution Chemistry

FIG. 5 shows the pH of the SC-slag suspensions with and without ligand (promising ligand dosages based on microcalorimetry results). Reference sample (SC) showed gradual increase in pH with time and reaches a steady pH of 13.1 between 72-160 h. Depending on the ligand, pH increase indicates the consumption of carbonate ions from the solution at the initial stages. TEA₂₅, TIPA₂₅, TKPP₂₅, and NTA₁₅₀ samples increased the pH of the system during the first 5 h. These results shows that incorporation of some ligands does increase the pH of the SC-activated BFS system. Amongst the studied ligands, NTA₁₅₀ showed the highest pH value and DHNP₂₅ showed the lowest. However, DHNP₂₅ accelerated the hydration kinetics of the SC-activated slag system more than NTA₁₅₀. This shows that pH does not entirely control the hydration kinetics of the system.

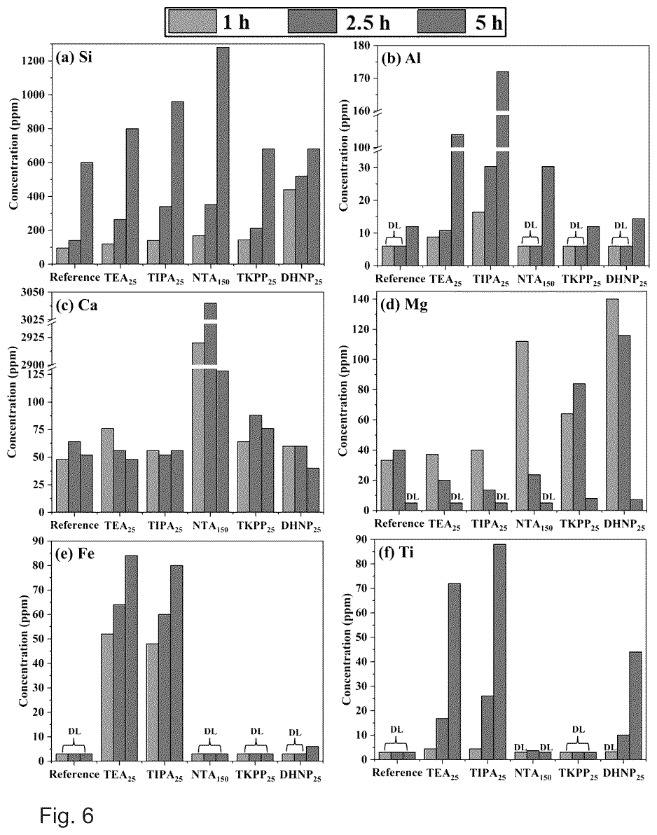

FIG. 6 shows the element concentrations in SC-slag suspensions with and without ligands. Without ligands, Al, Mg, Fe, and Ti were under detection limit of the ICP-MS in most measurement times. This implies that these metal ionic species precipitate, for example, as hydroxides, at these times by reaching their solubility limit. Increase in the concentration of these elements indicates ligand complexation with certain metal ionic species, and thus lowering the ion activity product (IAP) of the precipitating phases.

TEA and TIPA increased Fe and Al content in the pore solution. This can be due to complexing affinity of the ligands towards metal ions as it is strongly supported by literature evidence. TEA and TIPA do not increase Ca concentration in pore solution significantly even though they have affinity to complex Ca, which can be due to precipitation of poorly crystalline CH-ligand phases as indicated by the TGA results (FIGS. 4a-b). In contrast, NTA showed high increase in Ca concentration indicating formation of water-soluble complex with Ca at initial stages to form Ca—Na-NTA which can reach saturation at later stages and precipitate (FIG. 3b). This high complexing affinity of NTA towards Ca can accelerate the slag dissolution as there is increased total mass loss of the slag system is observed from TGA results (Table 2). NTA also increased Mg concentration in the pore solution during the first hour. However, from the results it shows that NTA has higher complexing affinity towards Ca than to Mg explaining the vast difference in their concentrations in the pore solution despite both metals being divalent. Formation of leach layer on the surface of the slag is possible as the Ca concentration is highly increased in the pore solution indicating preferential dissolution. Due to this leached layer, the H⁺ ions from the solution can charge compensate in place of Ca²⁺, which can reduce H⁺ ion concentration in solution thereby increasing the pH. TKPP shows increase in Mg concentration at the initial hours (until 2.5 h) indicating complexing affinity with it. In the presence of DHNP, increase in Si and Mg concentration in the early hours (until 2.5 h) is observed, but also with Ti at 5 h. The decrease in pH of the suspension in the initial stages can indicate consumption of hydroxide ions from the pore solution into the ligand-metal complex structure or other phases.

Considering the results from strength test and phase assemblage, the dissolution test conducted in this research study is in line in explaining the reaction process. Additionally, these results shows that ligand affect the pore solution chemistry depending upon the ligand functional group and eventual complexing affinity towards metal ions.

Elemental concentrations of a) silicon, b) aluminium, c) calcium, d) magnesium, e) iron, and f) titanium are shown in FIG. 6. Element concentrations of the SC sample (reference) are shown as horizontal-coloured dashed lines with symbol at the end representing respective reaction times.

### 4. Discussion

### 4.1 Reaction Mechanism of SC-Activated BFS System

When slag comes in contact with sodium carbonate solution, initial dissolution occurs (Eq. 1) and precipitation of carbonate salts like calcite and gaylussite in the pore solution begins (Eq. 2-3). This is confirmed by XRD (FIG. 3a) and TGA results (FIG. 4) of reference sample at 1 d in this study and in previous works as discussed in the introduction. However, the fate of other dissolved ions during carbonate salts formation has not been explored in detail in other studies. From the dissolution experiment results (FIG. 6) of the reference sample it was observed that Al, Mg, Fe, and Ti concentrations are under detection limit of ICP-MS at initial stages indicating their precipitation. XRD analysis of the dissolution samples (until 5 d; Fig. S6) showed no peaks corresponding to any smectite or LDH phases (like hydrotalcite), whereas only peaks corresponding to gaylussite and calcite was observed. This shows that Mg—Al—Fe—Ti phases might be amorphous or poorly crystalline (Eq. 4). There is a possibility that these phases can passivate the dissolution of ions from the BFS surface which can eventually slow down the carbonate consumption and delay the formation of strength producing gels (like C-(A)-S—H).

Once the pH of the system slowly starts to increase and carbonate ions being consumed to form carbonate salts and stable carbonate containing Mg—Al LDH phase (hydrotalcite), the Ca concentration in the pore solution reaches the saturation limit of C-(A)-S—H with Si and Al (Eq. 7). As the concentration of carbonate ions decreases in the pore solution with time, the gaylussite will slowly start to dissolve due to their metastable nature and converts to more stable form calcite (CaCO₃) and remaining carbonate from the gaylussite is consumed by the precipitating with hydrotalcite (Eq. 5, 6). These statements are supported by TG-DTG and XRD results of the reference sample (from 1-7 d) as the intensity of decarbonation peak decreases (around 600-800 °C) from 1-3 d and the XRD peaks and mass loss from the DTG results corresponding to the presence of hydrotalcite and C-(A)-S—H phases was confirmed from 3-7 d.

### Dissolution, Nucleation, Growth, and Precipitation During the First 1-2 Days

$$Slag + {Na}_{2} {CO}_{3} + {H}_{2} O \to Ca , Si , Al , Mg … ionic species + 2 {Na}^{+} + {CO}_{3}^{2} + {H}^{+} + {OH}^{-} \qquad ( 1 )$$

$${Ca}^{2 +} + {CO}_{3}^{2 -} \to {CaCO}_{3} ↓ ( calcite ) \qquad ( 2 )$$

$$2 {Na}^{+} + {Ca}^{2 +} + 2 {CO}_{3}^{2 -} + 5 {H}_{2} O \to {Na}_{2} {Ca ( {CO}_{3} )}_{2} \cdot 5 {H}_{2} O ( gaylussite ) \qquad ( 3 )$$

$$Mg + Al + Fe + Ti \pm other metal ions {\to }^{pH 11 - 12} amorphous phase \qquad ( 4 )$$

### Precipitation of Strength Forming Gels During the First 2-7 Days

$${\text{?}}_{2} \text{?} {( {CO}_{3} )}_{2} \cdot 5 {H}_{2} \text{?} {CO}_{3} ↓ + 2 {Na}^{+} + CO \text{?} + 5 \text{?} O \qquad ( 5 )$$

$$6 {Mg}^{2} + 2 {Al}^{3 +} + C \text{?} + 16 {OH}^{-} + 4 {H}_{2} O \to {Mg}_{6} {Al}_{2} C \text{?} ( OH \text{?} \cdot 4 {H}_{2} O ( hydrotalcite ) \qquad ( 6 )$$

$${Ca}^{2 +} ( C ) + {[ Al {( OH )}_{6} ]}^{3 -} ( A ) + Si \text{?} ( S ) + [ {OH}^{-} + {H}_{2} O ] ( H ) \to C - ( A - ) - S - H ↓ ge \text{?} \qquad ( 7 )$$

$$\text{?} \text{indicates text missing or illegible when filed}$$

### 4.2 Reaction Mechanism of Ligand-Assisted SC-Activated BFS System

The dissolution experiments showed that addition of ligands TEA, TIPA, NTA, and TKPP in the system increases the pH of the pore solution (FIG. 5) compared to reference (SC), accelerates the Si dissolution and other metal ions via complexation reactions, and eventually changes the IAP of the phases. This complexation behaviour with different metal ions is ligand specific. However, the ligand system containing DHNP, which lowered the pH of the system to 11.2, is comparatively lower than in reference system, while accelerating the hydration kinetics the most. This shows that there are other ways to accelerate the hydration of SC-activated BFS aside from just increasing the pH of the pore solution.

From the dissolution results and phase identification, TEA₂₅ and TIPA₂₅ showed that they can increase the Si, Al, Fe, Ti ion concentration in the pore solution (FIG. 6), which can affect the IAP of the precipitating cementitious phases.

Phase analysis of these samples showed similar results as reference. However, this course of action only accelerated the main exothermic peak that corresponds to final set and eventual hardening by about 7.5 h for TEA₂₅ and TIPA₂₅ (by comparing the time to achieve the exothermic peak maximum between reference and ligand system). However, with higher concentration (100 and 150 mM), TEA and TIPA did not accelerate the formation of main exothermic peak as much as with low concentration (25 mM) (FIG. 1a). One hypothesis could be due to Ca preferability on forming amorphous portlandite-ligand phase rather than forming carbonate salts which can prolong the time for carbonate consumption (intensity of the carbonate salts decreased with increasing concentration of the ligand as shown in FIG. 4a-b). It is observed that at triethanolamines concentration>0.1 wt. % in the binder system, the formation of portlandite-ligand phase can affect the strength of the binder by initiating microcracks formation. This could be the reason for the observed low strength for these system at increasing concentration (FIG. 2).

Based on dissolution experiments, NTA₁₅₀ increased the pH (FIG. 5) and accelerated the Ca dissolution immensely compared to other ligands (which is partly due to its higher ligand concentration and additional Na⁺ ions available from its structure, FIG. 6) by forming Ca—Na-NTA complexes (Section 3.3-3.4). Si concentration, which can be taken as an indication of the extent of slag dissolution (some Si phases may be precipitated despite the high L/S and short reaction time which can underestimate the total dissolved Si concentration), was the highest with NTA₁₅₀ (1280 ppm) compared to other ligand samples and SC (reference: 600 ppm). Even though NTA can accelerate the slag dissolution, NTA₁₅₀ accelerated the main exothermic peak only by about 9.5 hrs (FIG. 1b). This indicates that increasing the slag dissolution using ligands alone does not necessarily accelerate the hardening as it depends on the stability or association constant of the metal-ligand complexes. Additionally, the formation of the Ca-NaNTA can affect the IAP of carbonate salts by limiting Ca availability, consequently affecting carbonate consumption from the solution, reaction kinetics of C—S—H precipitation and thus affecting the acceleration of the hardening process of the binder.

However, based on strength results, the 7-day strength for NTA₁₅₀ was higher compared to other ligand system in FIG. 2 and reference, which can be due to increased extent of slag dissolution and precipitation of C-(A)-S—H phase as observed from XRD results (FIG. 3b).

Based on the microcalorimetry results, DHNP₂₅ accelerated the main exothermic peak by 28 h, while also increasing the 2-day strength from 2 MPa to 41 MPa. This indicates that DHNP was best in accelerating the hardening reaction of SC-activated BFS compared to other ligands. Based on the TGA results (FIGS. 4d & e), TKPP₂₅ and DHNP₂₅ ligands showed increased mass loss corresponding to Mg—Al LDH and C-(A)-S—H gel, but main difference was observed to be the mass loss corresponding to decarbonation of carbonate salts. TKPP ligand was observed to affect the reaction kinetics of carbonate salts (i.e., calcite and gaylussite), whereas DHNP did not. This indicates that hardening reaction of SC activated slag can be accelerated by not affecting the precipitation kinetics of carbonate salts but instead on the kinetics of other phases like LDHs and C-(A)-S—H, as the DHNP can influence the concentration of Mg and Si in the pore solution as observed from the results of dissolution studies.

These findings shows that a ligand can affect the reaction pathway of the phases in the binder system by controlling the IAP via altering the elemental concentration in the pore solution chemistry. Additionally, the result and discussion from this study shows that there are other routes to accelerate or improve the hydration kinetics of SC-activated slag apart from conventional routes of accelerating the carbonate ions consumption by forming stable carbonate phases and/or by increasing the pH of the system using additives as carried out in the past research studies.

### 5. Conclusions

The present disclosure investigated the effect of TEA, TIPA, NTA, TKPP, and DHNP at concentrations 25-150 mM on early-stage hydration of sodium carbonate-activated BFS. Based on the results, following conclusion can be drawn:
1. Nature of ligand functional group: DHNP, which has a dihydroxyl aromatic functional group, accelerated the hydration more than pyrophosphate-ligand TKPP, tripodal carboxylic amine-ligand NTA, or alkanolamine-ligands TEA and TIPA. Different ligand functional group has different complexing affinity with metal ions in the pore solution which consequently affects the reaction mechanism.
2. Ligand concentration: ligand concentration does not have a linear or a proportional relationship with hydration acceleration. Increasing the concentration did not necessarily accelerate the hydration kinetics by increasing the extent of dissolution for systems containing TEA, TIPA, TKPP, and DHNP (25 mM worked better than 100 or 150 mM), whereas it was vice versa for NTA (150 mM worked better than 25 or 100 mM). This shows that it is important to understand the underlying complex formation reactions between metals in pore solution and activator with and without ligand to use precise concentration in the mix designs for the right application, for example, acceleration of hydration or strength development at later stages.
3. Effect of ligand on phase formation: increasing concentration of TEA and TIPA are suspected to form amorphous portlandite-ligand phase, NTA formed Ca—Na-NTA crystalline phase, TKPP and DHNP did not show any formation of ligand precipitates according to TGA and XRD results.
4. pH and pore solution chemistry: ligands can influence the pore solution chemistry which may influence the IAP of the precipitating phases. All ligands increased Si concentration in the solution indicating increased extent of BFS dissolution. Even though the ligands increased the pH of the system, DHNP which performed best, had lowest pH at initial stages. This shows that higher pH of the pore solution does not necessarily accelerate hydration.
5. Effect of ligands on precipitation of carbonate salts: ligands TEA, TIPA, NTA, and TKPP can affect the speciation of Ca ions and formation of carbonate salts, which consequently affects carbonate ion consumption from the pore solution. This may be the reason that these ligands accelerated hydration by 7-12 h compared to reference sample. It appeared that DHNP did not affect the underlying carbonate salts precipitation kinetics unlike other ligands, while it affected the IAP of other precipitation products such as LDHs and C-(A)-S—H, by altering the Mg and Si ions concentration in the pore solution which might be the reason for acceleration of hydration by nearly 28 h.

These results shows that it is possible to accelerate the hydration of sodium carbonate activated BFS with help of ligands and to obtain sustainable SC-activated binders with low carbon footprint.

1. A method for hydrating multioxide silicate material, the method comprising
providing silicate mineral material,
providing solution containing an alkali activator and a ligand comprising a dihydroxy aromatic compound, and
mixing the silicate mineral material with the solution containing the alkali activator and the ligand to obtain hydrated silicate mineral material, such as hydrated multioxide silicate material.

2. The method of claim 1, wherein the dihydroxy aromatic compound does not comprise a non-fused catechol group.

3. The method of claim 1, wherein the dihydroxy aromatic compound comprises an aromatic ring structure with two or more aromatic rings attached to each other and comprising two hydroxyl functional groups.

4. The method of claim 1, wherein the dihydroxy aromatic compound comprises an aromatic ring structure with two hydroxyl functional groups that are attached to neighbouring carbon atoms of the aromatic ring.

5. The method of claim 1, wherein the dihydroxy aromatic compound is 2,3-dihydroxy aromatic compound.

6. The method of claim 5, wherein the 2,3-dihydroxy aromatic compound is 2,3-dihydroxynaphthalene.

7. The method of g claim 1, comprising adding the ligand into the alkali activator solution prior to mixing as dry powder or as water solution during raw material mixing, and/or as dry powder or as water solution during grinding process of the silicate mineral material.

8. The method of claim 1, wherein the silicate mineral material is selected from slag; ash; glass waste; mineral wool; and mine tailings.

9. The method of claim 1, wherein the alkali activator comprises sodium carbonate, potassium carbonate, sodium silicate and/or sodium sulphate; and/or wherein the alkali activator does not comprise sodium hydroxide.

10. The method of ag claim 1, wherein the concentration of the alkali activator in the solution is in a range of 0.1-15 M.

11. The method of claim 1, wherein the concentration of the ligand in the solution is in the range of 5-1000 mM.

12. The method of claim 1, wherein the ratio of the solution to the silicate mineral material is in the range of 0.2-1.

13. The method of claim 1, comprising
adding aggregate material and/or fibers to the mixture and/or to the hydrated silicate mineral material, and
mixing to obtain concrete.

14.-15. (canceled)

16. Hydrated silicate mineral material comprising a dihydroxy aromatic compound.

17. The hydrated silicate mineral material of claim 16, wherein the dihydroxy aromatic compound does not comprise a non-fused catechol group.

18. The hydrated silicate mineral material of claim 16, wherein the dihydroxy aromatic compound comprises an aromatic ring structure with two or more aromatic rings attached to each other and comprising two hydroxyl functional groups.

19. The hydrated silicate mineral material of claim 16, wherein the dihydroxy aromatic compound comprises an aromatic ring structure with two hydroxyl functional groups that are attached to neighbouring carbon atoms of the aromatic ring.

20. The hydrated silicate mineral material of claim 16, wherein the dihydroxy aromatic compound is 2,3-dihydroxy aromatic compound.

21. The hydrated silicate mineral material of claim 20, wherein the 2,3-dihydroxy aromatic compound is 2,3-dihydroxynaphthalene.

22. Concrete comprising aggregate material selected from material comprising sand, gravel, wood, glass, plastic, ceramic material, plant-based cellulose fibers and fibrils, and the hydrated silicate mineral material of claim 16.

23. A product comprising or consisting of ceramic-like or concrete material comprising the hydrated silicate mineral material of claim 16, selected from one or more of panels, boards, sheets, acoustic panels, tiles, slates, mortar, coating, basins, washbowls, toilet bowls, vases, pots, slabs, well rings or earth construction materials and products.

24.-30. (canceled)
